(19) United States
(12) Patent Application Publication
(10) Pub. No.: US 2002/0138829 A1
(43) Pub. Date: Sep. 26, 2002

(54) Receiving apparatus and method thereof, and storage medium therefor

(75) Inventors: Yuichi Matsumoto, Kanagawa (JP); Atsushi Mizutome, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/086,739

(22) Filed: Mar. 4, 2002

(30) Foreign Application Priority Data
Mar. 6, 2001 (JP) 2001-061677

(51) Int. Cl. H04N 7/16

(52) U.S. Cl. 725/14; 725/38

(57) ABSTRACT

Information can be smoothly retrieved according to a user view history and an operation history using a data receiving apparatus including a receiving unit for receiving a television broadcast signal of a broadcast program, an input unit for inputting program information of a broadcast program received by an external receiving apparatus, and a profile generation unit for generating a user profile according to the history of a broadcast program received by the receiving unit and the program information input by the input unit.

### BACKGROUND OF THE INVENTION

1. Field of the Invention

The present invention relates to a receiving apparatus and a method therof, and a storage medium therefor, and more specifically to the use and management of a user profile.

2. Related Background Art

In the current digital television broadcast using a communications satellite and a broadcast satellite, program information data (EPG: electronic program guide) is transmitted together with video and audio data as one of the viewer services. Furthermore, it is considered that a similar service is to be offered in a planned terrestrial digital television broadcast. The EPG information is effective when a user selects a channel, and, for example, the user can confirm the contents of the program being broadcast by generating and displaying a program list according to the EPG information.

In addition, in the digital television broadcast, programs can be provided on a number of channels. Therefore, the user has to select a broadcast channel on which a desired program is broadcasted. In this connection, there has been the technology of automatically searching for and retrieving a desired program from among a number of programs according to a past view history, etc.

A receiving system of the above mentioned digital television broadcast can be, in addition to a system of receiving and viewing a television broadcast through a normal television receiver, a system of recording the data of a desired program using a recording device such as a VTR having a television tuner, and then playing back the recorded data.

For example, a program broadcasted at midnight is recorded, and can be viewed later in the daytime.

In this case, when a program is recorded by a VTR, a television receiver is not used. Therefore, the television receiver does not record the view history that the program broadcasted at midnight was recorded by the VTR.

Therefore, programs such as sport programs which is broadcasted at midnight because they are worldwide broadcast are often viewed after recorded by users, and this view history is not reflected onto the program retrieving process as described above.

Therefore, a user cannot always correctly retrieve his or her desired program as a result of searching for desired programs.

### SUMMARY OF THE INVENTION

In the above mentioned situation, the present invention has been developed to solve the above mentioned problems, and aims at realizing effective information retrieval according to the user view history and the operation history.

To attain the purpose, according to aspect of the present invention, there is provided a data receiving apparatus, comprising:

receiving means for receiving a television broadcast signal of a broadcast program;

input means for inputting program information about a broadcast program received by an external receiving apparatus; and

profile generation means for generating a user profile based on a history of a broadcast program received by the receiving means and the program information input by the input means.

The above mentioned and other objects, and features of the present invention will become more apparent by reference to the following detailed description of the invention taken in conjunction with the accompanying drawings.

### BRIEF DESCRIPTION OF THE DRAWINGS

FIG. 1 is comprised of FIG. 1A and FIG. 1B showing block diagrams of the configuration of the receiving system to which the present invention is applied;

FIG. 2 is a flowchart for explaining the operation of the television receiver shown in FIGS. 1A and 1B;

FIG. 3 is comprised of FIG. 3A and FIG. 3B showing block diagrams of another configuration of the receiving system to which the present invention is applied;

FIG. 4 is a flowchart for explaining the operation of the recorder shown in FIGS. 3A and 3B; and

FIG. 5 is a flowchart for explaining the operation of the television receiver shown in FIGS. 3A and 3B.

### DESCRIPTION OF THE PREFERRED EMBODIMENTS

Embodiments of the present invention are described below in detail by referring to the attached drawings.

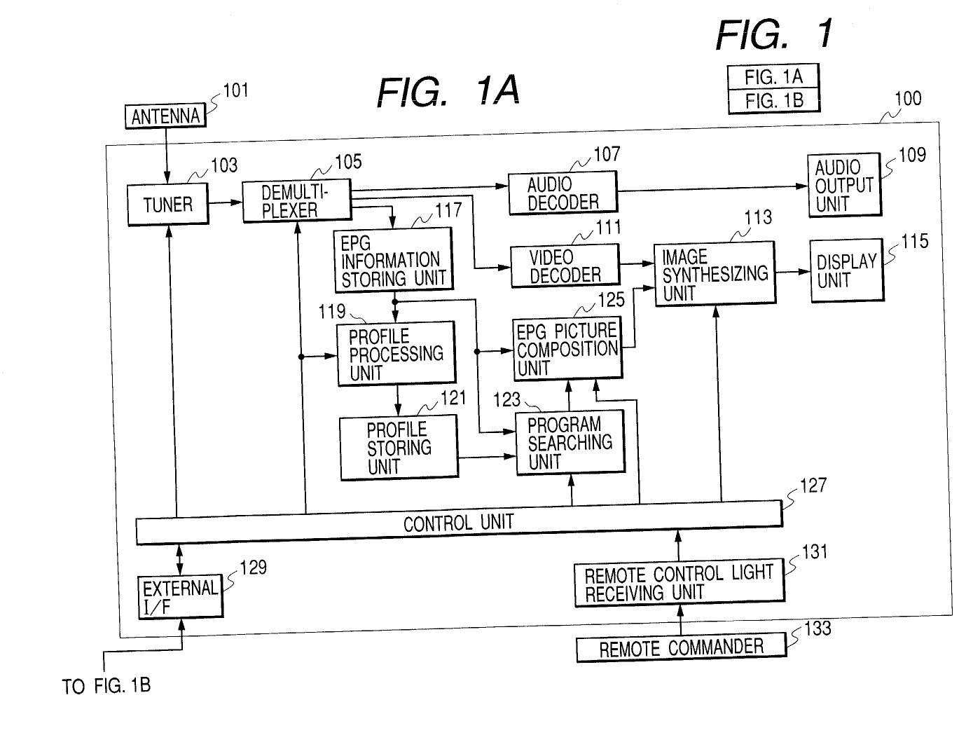

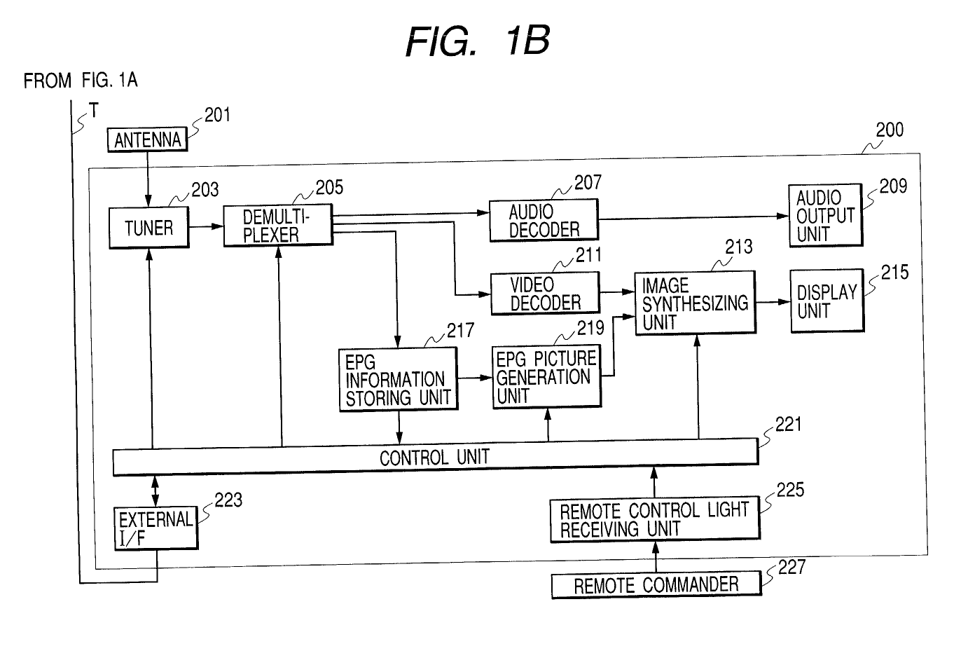

FIGS. 1A and 1B are block diagrams showing the configuration of the receiving system of the television broadcast to which the present invention is applied. The system shown in FIGS. 1A and 1B mainly comprises television receivers 100 and 200. According to an embodiment of the present invention, only the television receiver 100 has the function of searching for a program using a user profile.

First, in the television receiver 100, a tuner unit 103 detects a television broadcast signal of a channel specified from the television broadcast wave received by an antenna 101. Then a demodulating process, an error correcting process, etc. are performed on the television broadcast signal, and transport stream (TS) data prescribed by MPEG 2 is generated and output to a demultiplexer 105.

Normally, in a digital television broadcast, plural channels of video, audio, and data broadcast data are multiplexed into one broadcast wave, and the demultiplexer 105 retrieves video data and audio data on a desired channel from the TS data in which plural channels of video data, audio data, etc. output from the tuner unit 103 are time division multiplexed. Then, the audio data is output to an audio decoder 107, and the video data is output to a video decoder 111.

The audio decoder 107 decodes the audio data output from the demultiplexer 105, and outputs the decoded data to an audio output unit 109. The audio output unit 109 comprises a D/A converter, an amplifier, a speaker, etc., and outputs the audio data decoded by the audio decoder 107 as voice.

On the other hand, the video data output from the demultiplexer 105 is decoded by the video decoder 111. The decoded video data is output to an image synthesizing unit 113, and the video relating to the received television program is displayed on a display unit 115. As described above, the television receiver 100 is configured for viewing a desired program.

Additionally, the demultiplexer 105 extracts EPG data containing the information about programs being broadcasted and programs to be broadcasted from the TS data output from the tuner unit 103, and outputs the extracted data to an EPG information storing unit 117. The EPG information storing unit 117 stores the EPG data each time the EPG data is output from the demultiplexer 105.

A remote commander 133 has various keys for designation of the operations of the television receiver 100. A remote control receiving unit 131 receives/decodes infrared rays transmitted from the remote commander 133, and outputs the key code of a key operated by a user.

A control unit 127 integrally controls the tuner unit 103, the demultiplexer 105, the video decoder 111, the audio decoder 107, etc. based on the key code output from the remote control receiving unit 131, that is, a user operation. Furthermore, as described later, it also controls a profile processing unit 119 and a program searching unit 123.

The profile processing unit 119 detects the program information about the programs being viewed, from the EPG information stored in the EPG information storing unit 117 according to the control signal from the control unit 125, generates view history information, and stores it in the internal memory. Then, the profile processing unit 119 performs a predetermined arithmetic operation according to the view history information and user specific information such as an age, sex, etc. individually set by the user, generates user profile information, and stores it in a profile storing unit 121. Furthermore, if the user profile information has already been stored in the profile storing unit 121, the contents are updated.

A user profile is a user's personal database containing date, such as the day of week, and the time of a viewed program, the type of program such as music, sport, etc., the subtype of program such as baseball, football, etc., and supplementary information such as the name of a baseball team, the name of a baseball player, etc.

At an instruction to retrieve a program from the remote control commander 131, the control unit 127 outputs a control signal to instruct the program searching unit 123 to perform a program retrieving process. The program searching unit 123 performs a program retrieving process according to the EPG data stored in the EPG information storing unit 117 and the user profile information stored in the profile storing unit 121, and the result output to an EPG picture composition unit 125.

The EPG picture composition unit 125 generates an EPG picture based on the output of the program searching unit 123 in such a manner that a program selected as a result of retrieving a program can be easily distinguished from other programs, and outputs the data of the EPG picture to the image synthesizing unit 113.

The control unit 127 also outputs a control signal to the image synthesizing unit 113 at an instruction to retrieve a program, and displays the EPG picture from the EPG picture composition unit 125 on the display unit 115.

If profile information indicates, for example, that a larger number of sports programs are viewed, then the EPG picture obtained when a program is retrieved can be configured only by programs whose types are sports according to the EPG data stored in the EPG information storing unit 117.

Furthermore, for example, if user profile information indicates that a larger number of baseball programs have been viewed among sports programs, then the EPG picture can be configured only by the programs whose types are sports, and whose subtypes are baseball.

If a control unit 127 issues an instruction to display a normal EPG picture to the EPG picture composition unit 125, then the EPG picture composition unit 125 generates a normal EPG picture based on the EPG data stored in the EPG information storing unit 117, that is, the data of an EPG picture not considering the retrieval result from the program searching unit 123, and outputs the generated data to the image synthesizing unit 113. Then, the image synthesizing unit 113 selects the data of the EPG picture, and outputs the data to the display unit 115.

The user can operate an EPG picture including a program retrieval result displayed on the display unit and a normal EPG picture by operating a cursor key and an enter key of the remote commander 133, thereby switching channels.

An external I/F 129 receives program information and other information output as described later from an external device of the television receiver 100 through a communications line T, that is, from the television receiver 200 in the embodiment of the present invention. In the present embodiment, the external I/F 129 is an I/F for serial communications such as an RS 232C, etc., but it can be an I/F for parallel communications, cable communications, and radio communications.

The control unit 127 outputs the program information input from the external I/F 129 to the profile processing unit 119 in the format which can be recognized as the program information from an external receiver. The profile processing unit 119 stores the program information from the external receiver, provided by the control unit 127, in the internal memory. Then, as described later, the view history is updated based on the program information from the external receiver.

On the other hand, the television receiver 200 has almost the same configuration as the television receiver 100, but has no function of retrieving a program using the above mentioned user profile. Therefore, it has no configuration for the program retrieving process.

That is, a tuner 203 detects a television signal of a channel specified by a control unit 221 from the digital television broadcast wave received from an antenna 201, and outputs the detected signal as data in the format of the TS of the MPEG 2 to a demultiplexer 205. The demultiplexer 205 extracts audio data, video data, and EPG data from the TS data output from the tuner 203, and outputs the audio data to an audio decoder 207, the video data to a video decoder 211, and the EPG data to an EPG information storing unit 217, respectively.

The audio decoder 207 decodes the audio data from the demultiplexer 205, and outputs the result to an audio output unit 209. The audio output unit 209 outputs the audio according to the audio data output from the audio decoder 207. The video decoder 211 decodes the image data from the demultiplexer 205, and outputs the result to an image synthesizing unit 213. When a normal television broadcast is received, the image synthesizing unit 213 selects image data output from the video decoder 211, outputs the selected data to a display unit 215 to display an image according to the image data from the video decoder 211.

On the other hand, the EPG data from the demultiplexer 205 is output to the EPG information storing unit 217. The EPG information storing unit 217 stores the EPG data when it is output from the demultiplexer 205.

An EPG pictureproduction unit 219 reads the EPG data from the EPG information storing unit 217 if it receives an instruction to display a normal EPG picture from the control unit 221, generates the data of a normal EPG picture, and outputs the data to the image synthesizing unit 213. If the image synthesizing unit 213 receives an instruction to display an EPG picture from the control unit 221, then the image synthesizing unit 213 selects the EPG picture output from the EPG pictureproduction unit 219, outputs it to the display unit 215 to display a normal EPG picture.

A user can operate an EPG picture by operating a remote commander 227, thereby switching channels.

The control unit 221 controls the operation of each unit of the television receiver 200 according to the remote control code output by a remote control receiving unit 225, reads out program information about the program being viewed from the EPG information storing unit 217 when an instruction to switch channels is received from the remote commander 227, or when a viewed program is switched, and outputs the information to the external I/F 129 of the television receiver 100 through an external I/F 223. Like the external I/F 129 of the television receiver 100, the external I/F 223 is an I/F for serial communications such as the RS 232C, etc., but it can be an I/F for parallel communications, cable communications, or radio communications.

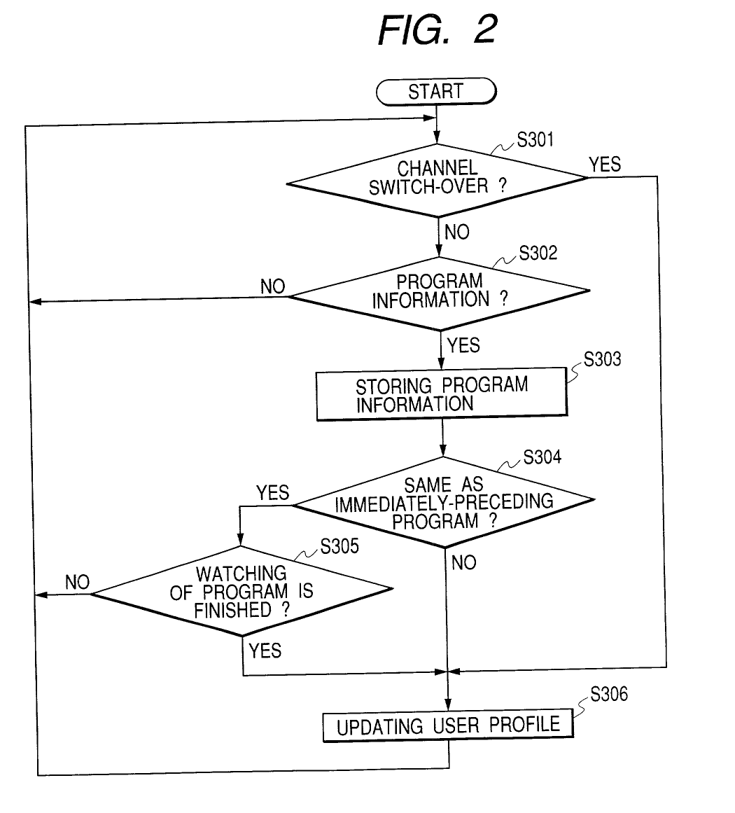

The process of managing a user profile in the system with the above mentioned configuration as shown in FIGS. 1A and 1B is described by referring to the flowchart shown in FIG. 2.

FIG. 2 is a flowchart showing the process of the management of the user profile by the control unit 127 of the television receiver 100. The flow shown in FIG. 2 is performed at a predetermined timing regardless of power-up or power-down of the television receiver 100.

In step S301, it is detected whether or not an instruction to switch channels has been issued by the remote commander 133. If the instruction to switch channels has been issued, then control is passed to step S306. If it has not been issued, then it is detected whether or not the external I/F 223 of the television receiver 200 has transmitted the program information relating to the program being viewed through the television receiver 200 (step S302). If the program information has not been input by the external I/F 129, then control is returned to step S301.

If the program information is input by the external I/F 129, the program information is output to the profile processing unit 119 (step S303).

When the control unit 127 inputs new program information, the profile processing unit 119 determines whether or not the new program information is the same as the program information input immediately before and stored in the internal memory (step S304). If they are different program information, then the new program information is stored together with the time information indicating the current time of an internal timer, and control is passed to step S306. If the newly-input program information is the same as the program information input immediately before, then the newly-input program information is not stored in the memory, and it is determined whether information for power-off of the television receiver 200 has been input together with the program information, that is, whether or not the information indicating the completion of viewing the program relating to the program information has been input. If the end of viewing the program is indicated, then the information indicating the viewing end time of the television receiver 200 is stored in the internal memory, and control is passed to step S306. If the end of viewing the program is not indicated, then control is returned to step S301 (step S305).

In step S306, when an instruction to switch channels is issued from the remote commander 133, the contents of the user profile are changed based on the difference between the time for the immediately-preceding instruction to switch channels and the time for the current instruction to switch channels, and the EPG data about the program viewed until the time immediately before. When program information is input from the television receiver 200, the user profile is changed based of the difference between the time at which the immediately-preceding program information is input and the time at which the current program information is input, and the program information input immediately before. When viewing end information is input from the television receiver 200, the user profile is changed based on the difference between the time at which the immediately-preceding program information is input and the time at which the current viewing end information is input, and the program information input immediately before.

The above mentioned process is described below by referring to a practical example.

For example, the viewing is started on the television receiver 200 at 18:00 which is receiving a news program. Then, at 19:00, the broadcast program on this channel is switched from the news program to a variety show program. Assume that user of the television receiver 200 switches the channel, the switched channel carries a drama program, and that the user further switches from the channel of the currently viewed program to the channel of a live broadcasting of a professional baseball game. Then, the user of the television receiver 200 views the live broadcasting of the professional baseball game, and the power for the television receiver 200 is turned off at 21:00, thereby terminating the viewing.

The operations of the television receivers 100 and 200 are described below.

First, at 18:00, the television receiver 200 outputs to the television receiver 100 through the external I/F 223 the program information about a news program together with the viewing start information relating to power-on. The profile processing unit 119 inputs the program information, and detects the start of viewing the news program on the television receiver 200.

At 19:00, the television receiver 200 outputs the program information about the variety show program to the television receiver 100. The profile processing unit 119 determines the end of viewing the news program and the start of viewing the variety show program on the television receiver 200. Then, a user profile is changed based on the information about the time period in which the user viewed the news program, that is, an hour, and the program information relating to the news program.

Then, a few seconds later in this example, the television receiver 200 outputs the program information about a drama program, and the profile processing unit 119 determines that the variety show program has ended and the user has started viewing the drama. However, since the time period in which the user viewed the variety show program is shorter than a predetermined time period, it determines that the user is less interested in the variety show program or that it only refers to a zapping operation, thereby changing no user profile. Similarly, a few seconds after outputting the program information about the drama program, the television receiver 200 outputs the program information about the live broadcasting of a professional baseball game as the receiver 200 switches the channel. Since the view time for the drama program is shorter than a predetermined time period, the user profile is not changed.

Then, at 21:00, since the television receiver 200 outputs the viewing end information together with the program information to the television receiver 100, the profile processing unit 119 changes the user profile based on the information about the time period in which the user viewed the live broadcasting of the professional baseball game, that is, 2 hours, and the program information about the live broadcasting of the professional baseball game.

Thus, if an instruction to retrieve a program is issued after the user profile has been changed, the program searching unit 123 retrieves a program based on the user profile reflecting the view history of the above mentioned news program and the live broadcasting of the professional baseball game.

Thus, according to the present embodiment, another receiver inputs program information about a program being viewed, and the user profile is changed based on the program information. Therefore, the generated user profile reflects the liking of a user.

Therefore, a program can be more smoothly retrieved or information can be more easily selected.

Described below is the second embodiment of the present invention.

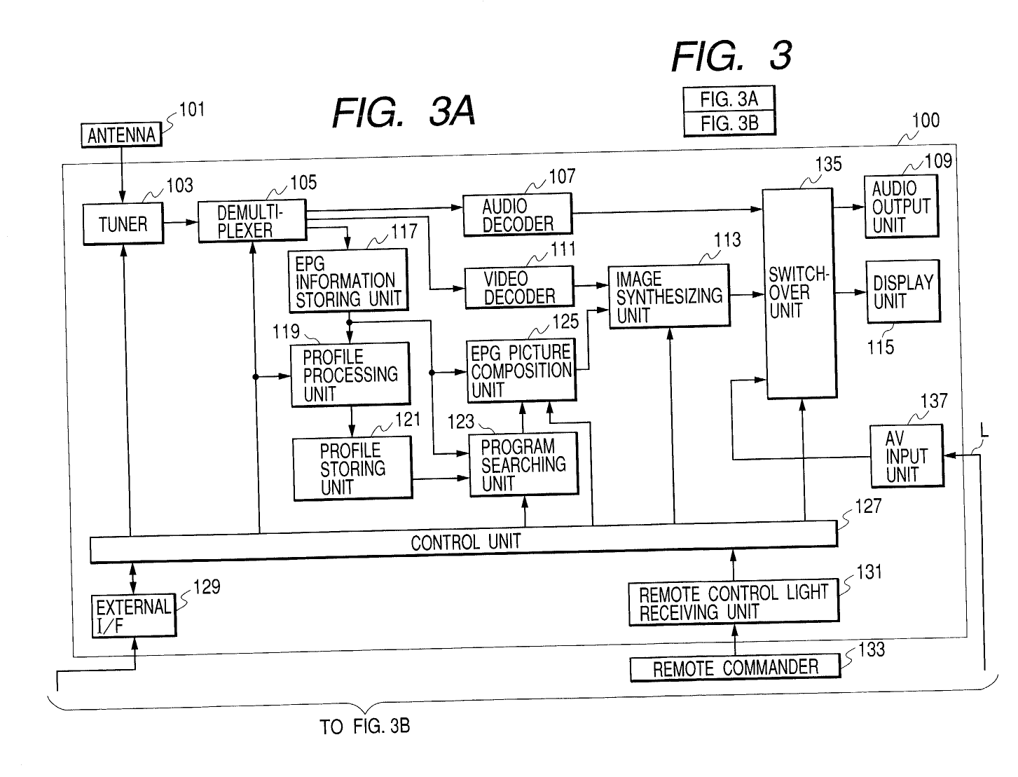

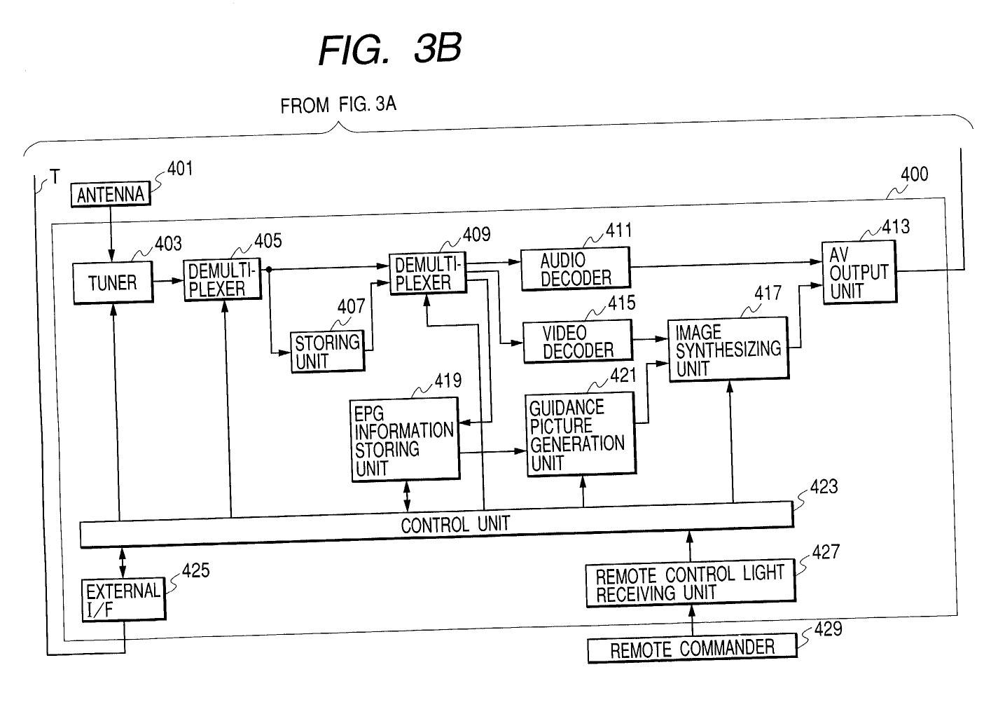

FIGS. 3A and 3B show the configurations of the digital television broadcast receiving system as the second embodiment of the present invention. The system shown in FIGS. 3A and 3B comprises the digital television receiver 100 and a digital broadcast recorder 400.

In FIGS. 3A and 3B, the television receiver 100 has almost the same configuration as the television receiver 100 shown in FIGS. 1A and 1B, but is different in that the audio data from the audio decoder 107 and the video data from the image synthesizing unit 113 are provided for the audio output unit 109 and the display unit 115 through a switching unit 135 respectively, and the audio and video data provided from the digital broadcast recorder 400 for an AV input unit 137 are provided for the audio output unit 109 and the display unit 115 through the switching unit 135.

That is, in the television receiver 100, the normal receiving operation is the same as in the above mentioned first embodiment. In this case, at an instruction from the remote commander 133, the control unit 127 controls the switching unit 135 such that the audio data from the audio decoder 107 and the video data from the image synthesizing unit 113 can be selected and output to the audio output unit 109 and the display unit 115.

On the other hand, when the video data and audio data output from the recorder 400 are monitored, the AV input unit 137 inputs the audio and video data strings output from the recorder 400 through the communications lines L, and outputs them to the switching unit 135. Upon receipt of an instruction to monitor the data from the recorder 400 through the remote commander 133, the control unit 125 controls the switching unit 135 such that the audio and video data from the AV input unit 137 can be selected and output to the audio output unit 109 and the display unit 115.

Furthermore, in the recorder 400, a tuner 403 receives a television broadcast wave of a channel specified by a control unit 425, and, like the tuner unit 103, changes the wave into a transport stream of the MPEG 2 and outputs the result to a demultiplexer 405.

At an instruction from the control unit 425, the demultiplexer 405 extracts the video and audio data on desired channels and the EPG information from the transport stream of the input MPEG 2, and outputs the extracted data to a storing unit 407 and a demultiplexer 409.

The storing unit 407 comprises a hard disk drive, a magneto-optic disk, etc., stores the data output from the demultiplexer 405, reproduces the video, audio, and EPG data stored according to the instruction from a control unit 423, and outputs the reproduced data to the demultiplexer 409. In addition, at an instruction from the control unit 425, the demultiplexer 409 selects and inputs the data string output from the demultiplexer 405 or the storing unit 407. Then, video, audio, and EPG data are detected from the input data strings, and the audio data is output to an audio decoder 411, the video data is output to a video decoder 415, and the EPG data is output to the EPG information storing unit 419.

The audio decoder 411 decodes the audio data from the demultiplexer 409, and outputs the decoded data to an AV output unit 413. The video decoder 415 decodes the video data from the demultiplexer 409, and outputs the decoded data to the AV output unit 413 through an image synthesizing unit 417. The AV output unit 413 converts the audio data and the video data into a format appropriate for outputting them to the television receiver 100, and outputs the data to the AV input unit 137 of the television receiver 100 through the communications lines L.

An EPG information storing unit 419 stores the EPG data output from the demultiplexer 409, and outputs the data to a guidance pictureproduction unit 421 as necessary, and outputs the EPG data detected from the data reproduced from the storing unit 407 to the control unit 423 at an instruction from a control unit 423.

At an instruction from the control unit 423, the guidance pictureproduction unit 421 generates a guide picture indicating a list of program information formed by the video and audio data stored in the storing unit 407 in addition to a normal EPG picture, based on the EPG data stored in the EPG information storing unit 419, and outputs the image data of these EPG and guidance pictures to the image synthesizing unit 417.

The image synthesizing unit 417 composes the video data from the video decoder 415 with the image data from the guidance pictureproduction unit 421, and outputs the result to the AV output unit 413. Thus, by generating the EPG and guidance pictures, the user can easily switch the channels, and easily select video and audio data to be reproduced from the storing unit 407.

Furthermore, the control unit 423 receives commands from a remote commander 429 through a remote control receiving unit 427, and controls the operations of the recorder 400 according to the commands.

Then, at an instruction to switch channels or reproduce the data from the storing unit 407 from the remote commander 429, the control unit 423 generates program information according to the EPG data stored in the EPG information storing unit 419 at that time point, and outputs the generated information to the external I/F 129 of the receiver 100 through the external I/F 425.

That is, when the recorder 400 is set in a television view mode by the remote commander 429, the control unit 423 reads out the program information about the program being broadcast on the current channel, from the EPG information storing unit 419 at an instruction to switch channels, and outputs the read-out program information to the receiver 100 through the external I/F 425. When the television view terminates, the information indicating this termination is given together with the program information to the receiver 100.

When the recorder 400 is set in a reproduction mode by the remote commander 429 in which the reproduced data from the storing unit 407 is to be viewed, the program information detected from the reproduced data is read out from the EPG information storing unit 419, and output to the receiver 100 through the external I/F 425. At an instruction to complete the reproduction, the reproduction end information is output to the receiver 100 together with the program information which is based on the EPG data stored in the EPG information storing unit 419 at this time point.

Thus, according to the present embodiment, in addition to the program information relating to the program being viewed on the recorder 400, the program information about the reproduced data is output to the receiver 100 when the data stored in the storing unit 407 is reproduced. Then, the receiver 100 can obtain a user profile according to the liking of the user by changing the contents of the user profile based on the program information output from the recorder 400 as in the above-mentioned first embodiment of the present invention.

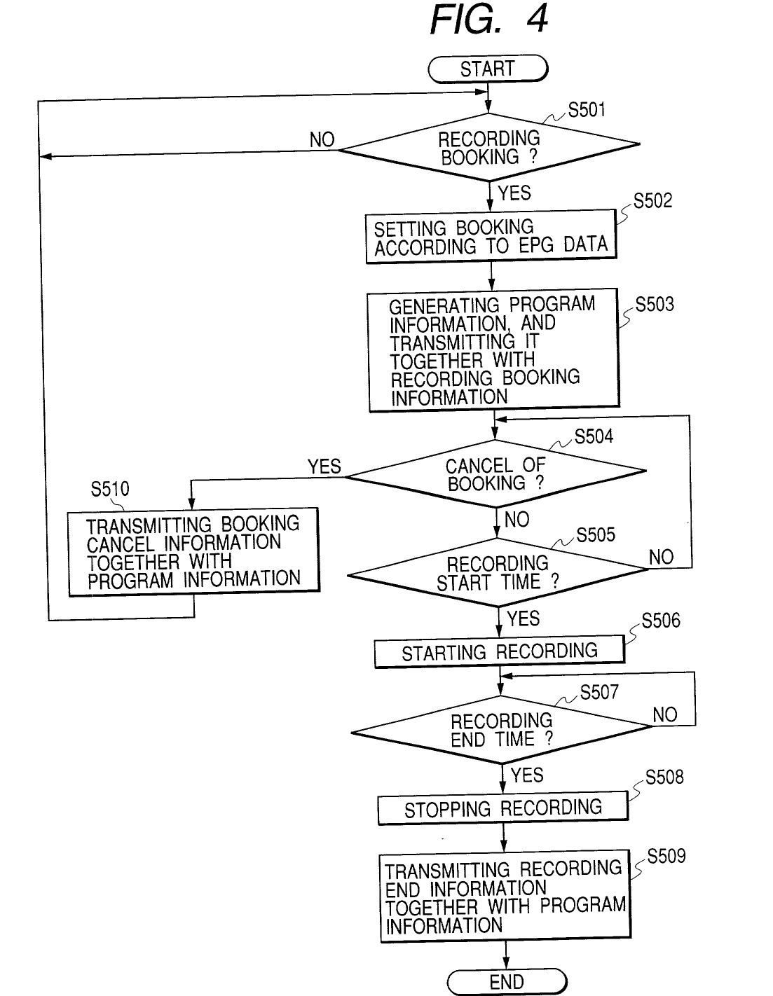

Furthermore, the recorder 400 of the present embodiment can program a recording schedule by operating the EPG picture generated by the guidance picture generation unit 421 through the remote commander 429. When a recording schedule is set, the program information about a program to be recorded is being transmitted to the receiver 100. The operation of the recorder 400 for recording a scheduled program is described below by referring to the flowchart shown in FIG. 4.

FIG. 4 is a flowchart of the operations of the control unit 423 for making a recording schedule for a program in the recorder 400 in FIG. 3B.

The remote commander 429 first specifies a program with the EPG picture displayed. If an instruction to book the recording of the specified program is issued (step S501), then the booking is set in the internal memory based on the information about the start and end date and time of the specified program based on the EPG data stored in the EPG information storing unit 419 (step S502), the program information about the booked program is generated, and output to the receiver 100 through the external I/F 425 together with the information about the booking of recording the program (step S503).

Then, the cancellation of the booked recording is monitored until the recording start time (step S504). If it is canceled, the program information about the canceled program and the booking cancellation information are generated and transmitted to the receiver 100 (step S510). If no instruction to cancel the booking is issued, and the recording start time is reached (step S505), then the recording of the booked program is started (step S506).

If the recording end time for the booked program is reached (step S507), then the recording is stopped (step S508), and the program information about the program and the recording end information are generated and output to the receiver 100 (step S509).

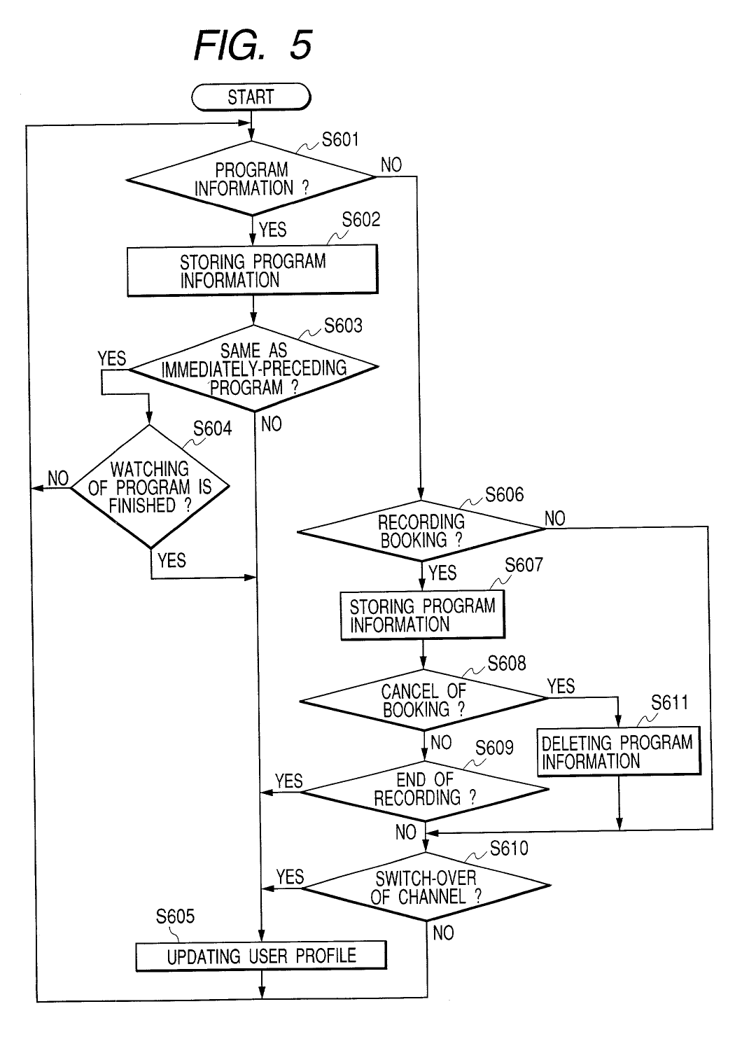

Then, the process of changing the user profile by the receiver 100 according to the recording booking information from the recorder 400 is described below by referring to the flowchart shown in FIG. 5. FIG. 5 is a flowchart for explaining the process of the user profile by the control unit 127 in the receiver 100. The flow is executed periodically at a predetermined timing.

First in FIG. 5, it is detected whether or not program information is transmitted from the recorder 400 (step S601). As described above, the recorder 400 outputs program information to the receiver 100 both in the television view mode in which the data from the demultiplexer 405 is viewed as is, and in the reproduction mode in which the data from the reproduced storing unit 407 is viewed. However, it doesn't count which mode is currently entered.

When program information is input, the control unit 127 outputs the program information to the profile processing unit 119, and stores it together with the reception time information in the internal memory (step S602). Then, it checks whether or not the program information is the same as the program information transmitted immediately before (step S603). If they are the same as each other, it further checks whether or not viewing end information is added to the program information. If yes, then control is passed to step S604. If the program is different from the program information immediately before in step S603, then control is passed to step S605.

If the program information had not been input in step S601, then it is checked whether or not recording booking information has been input (step S606). If the recording booking information has not been input either, then the remote commander 133 detects whether or not an instruction to switch channels has been issued by the remote commander 133. If no instruction to switch channels has been issued, then control is returned to step S601 again (step S610). If an instruction to switch channels has been issued, then control is passed to step S605.

If recording booking information has been input in step S606, then the program information transmitted together with the recording booking information is stored in the memory of the profile processing unit 119 (step S608). Then, if the booking cancellation information about the program is monitored (step S608), and the booking cancellation information is transmitted from the recorder 400, then the program information about the program is deleted from the memory of the profile processing unit 119 based on the program information added to the booking cancellation information, and control is passed to step S610. If the booking cancellation information has not been input and the recording end information is transmitted from the recorder 400, then control is passed to step S605.

Then, in step S605, the process of updating a user profile is performed by the profile processing unit 119.

That is, if the program information input in step S603 is different from the program information immediately before, then the profile processing unit 119 computes the view time from the input time of the program information immediately before and the input time of the current program information, and updates the contents of the user profile based on the program information immediately before when the view time is longer than a predetermined time.

If the viewing end information is input in step S604, then the profile processing unit 119 computes the view time from the input time of the program information immediately before and the input time of the current program information, and updates the contents of the user profile based on the information about the current program when the view time is longer than a predetermined time.

If the booked recording end information in the recorder 400 is input in step S609, then the contents of the user profile are updated based on the program information input together with the recording booking information and stored in the internal memory. According to the present embodiment, the user profile of the booked and recorded program is updated regardless of the length of the record time (view time). This means that to book a program to be recorded refers to the higher interest of the user, and it is considered that the program is to be included in the contents of the user profile although it is a short broadcast (recording).

Furthermore, if an instruction to switch channels is issued in step S610, then the view time of the current program is detected from the difference between the immediately previous switching time and the current switching time. If the view time is longer than a predetermined time, then the contents of the user profile are updated according to the EPG data stored in the EPG information storing unit 117.

Thus, according to the present embodiment, in addition to the normal television view mode, the program information about the reproduced data is transmitted to the receiver 100 when the data stored in the storing unit 407 is reproduced, and the receiver 100 updates the user profile based on the program information about the reproduced data. Therefore, although a broadcast program is recorded and then viewed later, the contents of the recorded program can be reflected in the contents of the user profile.

Furthermore, according to the present embodiment, when the recorder 400 books a program to be recorded, and completes the recording, the program information is transmitted together with the recording booking information to the receiver 100, and the contents of the user profile are changed according to the booking information and program information. Therefore, a program in which a user takes higher interest, including a booked program, can be reflected in the contents of the user profile.

According to the above-mentioned embodiment, after inputting the recording booking information, the contents of the user profile are updated when the recording end information is input. However, for example, the contents of the user profile can be updated when the recording booking information is transmitted together with the program information. Furthermore, the booked recording end information can be transmitted together with the program information from the recorder 400 only when booked recording terminates, and the receiver 100 can change the contents of the user profile when the recording end information is received.

In addition, between a booked and recorded program and a simply viewed program on the recorder 400, the weight to the user profile can be varied.

The recording start and end information and the program information can be transmitted to the receiver 100 during recording while viewing and at a time when stopping recording, as well as during recording after booking, and the receiver 100 can update the user profile according to the recording start and end information and the program information. In this case, to record a program even during viewing indicates high interest of the user. Therefore, the weight to the user profile can be set larger. Furthermore, the weight can be varied depending on the time period from the recording start time to the recording end time.

Additionally, according to the present embodiment, the process of decoding audio data, the retrieving process using a user profile, the process of updating the user profile, etc. are realized in a hardware configuration, but the process, etc. shown in FIGS. 2 and 4 can be realized by a software process using a microcomputer.

At this time, the program code of the above-mentioned software realizes the function of the above-mentioned embodiments, and the program code itself, means for providing the program code for a computer, for example, a storage medium storing such a program code configure the present invention. The storage medium storing such a program code can be, for example, a floppy disk, a hard disk, an optical disk, a magneto-optic disk, a CD-ROM, a magnetic tape, a non-volatile memory card, an ROM, etc.

The embodiments of the present invention also includes a program code not only when the functions described above by referring to the embodiments of the present invention can be realized by executing the program code for which a computer is assigned, but also when the functions according to the above-mentioned embodiments are realized by the cooperation of the OS (operating system) in which the program code is operating in a computer, and other application software, etc.

Furthermore, after the provided program code is stored in the memory of a function extension board of a computer and a function extension unit connected to a computer, a part or all of the actual process can be performed by the CPU, etc. provided for the function extension board and the function extension unit at an instruction of the program code, thereby realizing the function according to the above-mentioned embodiments. This also is included in the present invention.

As described above, according to the present invention, an appropriate information retrieving process can be realized according to the user view history and the operations history.

Many widely different embodiments of the present invention may be constructed without departing from the spirit and scope of the present invention. It should be understood that the present invention is not limited to the specific embodiments described in the specification, except as defined in the appended claims.

What is claimed is:

1. A data receiving apparatus, comprising:
receiving means for receiving a television broadcast signal of a broadcast program;
input means for inputting program information about a broadcast program received by an external receiving apparatus; and
profile generation means for generating a user profile based on a history of a broadcast program received by said receiving means and the program information input by said input means.

2. The apparatus according to claim 1, further comprising
searching means for searching for a program in the television broadcast signal received by said receiving means based on the user profile.

3. The apparatus according to claim 2, further comprising:
picture generation means for generating a guidance picture based on a search result of said searching means; and
display control means for outputting image data of the guidance picture generated by said picture generation means to a display device.

4. The apparatus according to claim 1, wherein
said profile generation means detects a view time of a program associated with the program information based on the program information input by said input means, and generates said user profile based on the detected view time.

5. The apparatus according to claim 4, wherein
said profile generation means generates a user profile based on said program information when said view time is longer than a predetermined time.

6. The apparatus according to claim 1, wherein
said input means further inputs information indicating power-off of said external receiving apparatus, and
wherein said profile generation means further generates said user profile based on the information indicating said power-off and the input program information.

7. The apparatus according to claim 1, wherein
said external receiving apparatus can record and reproduce data of a received broadcast program on and from a storage medium, and
wherein said input means further input program information of data reproduced from said storage medium.

8. The apparatus according to claim 1, wherein
said external receiving apparatus can further book recording a received broadcast program, and
wherein said input means further inputs program information of said program for which recording is booked in the external apparatus.

9. The apparatus according to claim 8, wherein
said profile generation means varies a weight to the user profile between said program information of a program received by the external receiving apparatus and program information of said program for which recording is booked.

10. The apparatus according to claim 8, wherein
said input means further inputs recording end information of the booked program, and
wherein said profile generation means varies a weight to the user profile between said program information of a program relating to the recording end information and program information of a program received by the external receiving apparatus.

11. The apparatus according to claim 1, wherein said external receiving apparatus can record data relating to a received broadcast program on a storage medium, and
wherein said input means further inputs program information oft said stored data into the storage medium.

12. A data receiving apparatus, comprising:
receiving means for receiving a television broadcast signal of a broadcast program;
input means for inputting program information of a broadcast program received by an external receiving apparatus; and
profile generation means for generating a user profile based on program information input through said input means.

13. A data receiving apparatus, comprising:
receiving means for receiving a television broadcast signal of a broadcast program; and
output means for outputting program information of a broadcast program received from said receiving means to an external receiving apparatus, wherein
said external receiving apparatus inputs said program information and generates a user profile based on said program information.

14. The apparatus according to claim 13, wherein said output means outputs said program information to said external receiving apparatus in response to a change of a broadcast program received by said receiving means.

15. The apparatus according to claim 13, wherein said output means outputs said program information in response to power-on of said receiving apparatus.

16. The apparatus according to claim 13, wherein said output means further outputs reception end information in response to power-off of said receiving apparatus to said external receiving apparatus, and
wherein said external receiving apparatus further generates the user profile based on the reception end information.

17. The apparatus according to claim 1, further comprising:
recording and reproduction means for recording and reproducing data relating to a broadcast program received by said receiving means on and from a storage medium, wherein said output means outputs program information of data reproduced from said storage medium.

18. The apparatus according to claim 17, wherein said recording and reproduction means can further book data of said broadcast program to be recorded on said storage medium, and
wherein said output means outputs program information of said program booked for recording.

19. A method for receiving a television broadcast signal by a receiving apparatus, comprising:
a receiving step of receiving a television broadcast signal of a broadcast program;
an input step of inputting program information of a broadcast program received by an external receiving apparatus; and
a profile generating step of generating a user profile based on a history of a broadcast program received in said receiving step and the program information input in said input step.

20. The method according to claim 19, further comprising:
a searching step of searching for a program in the television broadcast signal received in said receiving step based on said user profile.

21. The method according to claim 20, further comprising:
a picture generating step of generating a guidance picture based on a search result of said searching step; and
a display control step of outputting image data of the guidance picture generated by said picture generating step to a display device.

22. The method according to claim 19, wherein said profile generating step detects a view time of a program associated with the program information based on the program information input by said input step, and generates said user profile based on the detected view time.

23. The method according to claim 22, wherein said profile generating step generates a user profile based on said program information when said view time is longer than a predetermined time.

24. The method according to claim 19, wherein said input step further inputs information indicating power-off of said external receiving apparatus, and
wherein said profile generating step further generates said user profile based on the information indicating said power-off and the input program information.

25. The method according to claim 19, wherein said external receiving apparatus can record and reproduce data of a received broadcast program on and from a storage medium, and
wherein said input step includes a step of inputting program information of data reproduced from said storage medium.

26. The method according to claim 19, wherein said external receiving apparatus can further book recording a received broadcast program, and
wherein said input step includes a step of inputting program information of a program for which recording is booked in said external apparatus.

27. The method according to claim 26, wherein said profile generating step varies a weight to the user profile between said program information of a program received by said external receiving apparatus and said program information of a program for which recording is booked.

28. The method according to claim 26, wherein said input step further inputs recording end information of the booked program, and
wherein said profile generating step varies a weight to said user profile between said program information of a program relating to the recording end information and said program information of a program received by the external receiving apparatus.

29. The method according to claim 19, wherein said external receiving apparatus can record data relating to a received broadcast program on a storage medium, and
wherein said input step includes a step of inputting program information of stored data into the storage medium.

30. A storage medium storing a program for realizing the method according to claim 19 using a computer.

31. A method for receiving a television broadcast signal by a data receiving apparatus, comprising:
a receiving step of receiving a television broadcast signal of a broadcast program;
an input step of inputting program information of a broadcast program received by an external receiving apparatus; and
a profile generating step of generating a user profile information according to said input program information.

32. A storage medium storing a program for realizing the method according to claim 31 using a computer.
